(19) United States
(12) Patent Application Publication
(10) Pub. No.: US 2026/0155976 A1
(43) Pub. Date: Jun. 4, 2026

(54) PORTABLE FILE SYSTEM STRUCTURE USING NON-FUNGIBLE TOKENS

(71) Applicant: TOKENFORM LLC, Denver, CO (US)

(72) Inventors: Jeffrey Binder, Denver, CO (US); Charles Hasek, Denver, CO (US); Lindsay Gardner, West Hollywood, CA (US)

(21) Appl. No.: 18/968,751

(22) Filed: Dec. 4, 2024

(51) Int. Cl. H04L 9/32; G06F 16/13

(52) U.S. Cl. CPC H04L 9/3213; G06F 16/134

(57) ABSTRACT

A portable file system structure that uses NFTs allows access to information regarding a directory structure using one or more directory NFTs. This may be used to view and/or modify the directory structure via one or more front ends. Access to one or more of the files themselves, and or decryption of encrypted content, may be obtained via one or more access NFTs, one-time passwords, and/or other authorization mechanisms. The files themselves may be stored in one or more different storage locations, such as cloud storage. The storage locations may be changed independently of the front end, and a front end associated with the directory structure may be de-associated so that another front end may be associated and then used to view and/or modify the directory structure.

### FIELD

The described embodiments relate generally to file systems. More particularly, the present embodiments relate to a portable file system structure using non-fungible tokens.

### BACKGROUND

A blockchain is a distributed ledger that is shared among nodes of a decentralized computer network. Blockchains are similar to databases in that they store information electronically in digital format. However, unlike a database, blockchains collect information together in groups, known as blocks. As blocks are filled they are closed, timestamped, and linked to a previously filled block. This data structure inherently makes an irreversible timeline of data when implemented in a decentralized nature.

One use of blockchains is to store non-fungible tokens (NFTs). NFTs are cryptographic assets on a blockchain with unique identification codes and metadata that distinguish them from each other. NFTs are typically used to represent rights to real world assets, such as artworks. NFTs are associated with a smart contract stored on the blockchain that controls transactions that can be performed with the NFTs and who can perform them. NFTs are accessible using private and/or public keys stored in a local and/or cloud-based token wallet assigned to the owner of the respective NFT, and ownership is tracked on the blockchain.

### OVERVIEW

The present disclosure relates to a portable file system structure that uses NFTs. Access to information regarding a directory structure may be obtained using one or more directory NFTs. This may be used to view and/or modify the directory structure via one or more front ends. Access to one or more of the files themselves, and or decryption of encrypted content, may be obtained via one or more access NFTs, one-time passwords, and/or other authorization mechanisms. The files themselves may be stored in one or more different storage locations, such as cloud storage. The storage locations may be changed independently of the front end, and a front end associated with the directory structure may be de-associated so that another front end may be associated and then used to view and/or modify the directory structure.

In various embodiments, a system includes a non-transitory storage medium that stores instructions and at least one processor. The at least one processor executes the instructions to generate a directory NFT (non-fungible token) for a directory structure associated with stored files, generate at least one access NFT for at least some of the stored files, allow access to information regarding the directory structure via the directory NFT, allow modification of the directory structure via the directory NFT, and allow access to the at least some of the stored files via the at least one access NFT.

In some examples, the information regarding the directory structure is stored in the directory NFT. In a number of examples, the information regarding the directory structure is stored in a directory file referenced by the directory NFT. In various examples, the information regarding the directory structure is stored in a blockchain associated with the directory NFT. In some examples, the information regarding the directory structure is in extensible markup language.

In a number of examples, the information regarding the directory structure includes a reference to a storage location of at least one of the stored files. In some implementations of such examples, the reference is to a directory service instead of an actual location of the at least one of the stored files.

In various examples, the modification of the directory structure modifies the information regarding the directory structure. In some examples, the modification of the directory structure includes revoking the directory NFT and creating a new directory NFT.

In a number of examples, at least one of the stored files is a document. In various examples, the at least one processor further executes the instructions to present the information regarding the directory structure via at least one front end. In some examples, at least a portion of the stored files are stored in a distributed internet protocol file system storage. In a number of examples, the at least one processor further executes the instructions to encrypt at least part of the stored files using a token, determine to search the at least part of the stored files for at least one search term, encrypt the at least one search term using the token to form at least one encrypted search term, and use the directory NFT and the at least one encrypted search term to search the at least part of the stored files.

In some embodiments, a method includes associating a first front end with a directory NFT (non-fungible token) for a directory structure associated with stored files, using the first front end to access information regarding the directory structure via the directory NFT, de-associating the first front end from the directory NFT, associating a second front end with the directory NFT, and using the second front end to access the information regarding the directory structure via the directory NFT.

In various examples, the first front end and the second front end depict the information regarding the directory structure differently. In some examples, the method further includes accessing at least one of the stored files via the second front end using at least one access NFT associated with the at least one of the stored files.

In a number of embodiments, a computer program product includes first instructions stored in a non-transitory computer-readable medium and executable by at least one processing unit to determine to store one or more files in one or more first storage locations, second instructions stored in the non-transitory computer-readable medium and executable by the at least one processing unit to create a directory structure for the one or more files using the one or more first storage locations, third instructions stored in the non-transitory computer-readable medium and executable by the at least one processing unit to generate a directory NFT (non-fungible token) for the directory structure, fourth instructions stored in the non-transitory computer-readable medium and executable by the at least one processing unit to move the one or more files from the one or more first storage locations to one or more second storage locations, and fifth instructions stored in the non-transitory computer-readable medium and executable by the at least one processing unit to update at least one of the directory NFT or a directory service for the move.

In various examples, the directory structure specifies at least one of an access permission, a list of the one or more files, and at least one relationship between the one or more files. In some examples, the directory service is implemented by a directory service NFT. In a number of examples, moving the one or more files from the one or more first storage locations to the one or more second storage locations includes verifying that a requestor of the move is associated with at least one access NFT associated with the one or more files.

### BRIEF DESCRIPTION OF THE DRAWINGS

The disclosure will be readily understood by the following detailed description in conjunction with the accompanying drawings, wherein like reference numerals designate like structural elements.

FIG. 1A depicts an example system.

FIG. 1B depicts a flow of using creation and minting of a smart contract and a non-fungible token. The flow may be performed by the system of FIG. 1A.

FIG. 1C depicts a list of backend services. The backend services may support and/or be provided by the system of FIG. 1A.

FIG. 1D depicts mint-print-manage functions. The mint-print-manage functions may be performed and/or supported and/or provided by the system of FIG. 1A.

FIG. 1E depicts an implementation of a portable file system structure using non-fungible tokens.

FIG. 2 depicts a flow chart illustrating a first example method involving a portable file system structure using non-fungible tokens. This method may be performed by the system of FIG. 1A.

FIG. 3 depicts a flow chart illustrating a second example method involving a portable file system structure using non-fungible tokens. This method may be performed by the system of FIG. 1A.

FIG. 4 depicts a flow chart illustrating a third example method involving a portable file system structure using non-fungible tokens. This method may be performed by the system of FIG. 1A.

FIG. 5 depicts a flow chart illustrating a fourth example method involving a portable file system structure using non-fungible tokens. This method may be performed by the system of FIG. 1A.

FIG. 6 depicts a flow chart illustrating a fifth example method involving a portable file system structure using non-fungible tokens. This method may be performed by the system of FIG. 1A.

FIG. 7 depicts a flow chart illustrating a sixth example method involving a portable file system structure using non-fungible tokens. This method may be performed by the system of FIG. 1A.

FIG. 8 depicts a flow chart illustrating a seventh example method involving a portable file system structure using non-fungible tokens. This method may be performed by the system of FIG. 1A.

FIG. 9 depicts a flow chart illustrating an eighth example method involving a portable file system structure using non-fungible tokens. This method may be performed by the system of FIG. 1A.

FIG. 10 depicts a flow chart illustrating a ninth example method involving a portable file system structure using non-fungible tokens. This method may be performed by the system of FIG. 1A.

FIG. 11 depicts a flow chart illustrating a tenth example method involving a portable file system structure using non-fungible tokens. This method may be performed by the system of FIG. 1A.

FIG. 12 depicts a flow chart illustrating an eleventh example method involving a portable file system structure using non-fungible tokens. This method may be performed by the system of FIG. 1A.

FIG. 13 depicts a flow chart illustrating a twelfth example method involving a portable file system structure using non-fungible tokens. This method may be performed by the system of FIG. 1A.

FIG. 14 depicts a flow chart illustrating a thirteenth example method involving a portable file system structure using non-fungible tokens. This method may be performed by the system of FIG. 1A.

FIG. 15 depicts example relationships among example components that may be used to implement the system of FIG. 1A.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The description that follows includes sample systems, methods, apparatuses, and computer program products that embody various elements of the present disclosure. However, it should be understood that the described disclosure may be practiced in a variety of forms in addition to those described herein.

A file system is a structure used to organize and manage files stored on one or more storage devices. In some cases, the files may be stored on local storage devices. However, a distributed file system is a file system that spans across multiple file servers or multiple locations, such as file servers that are situated in different physical places. A directory structure is a file system structure that organizes files into a hierarchy of folders or similar structures that involve a hierarchical relationship between one or more of the files. Such a hierarchy may be conceptually described as opposed to a literal structure in which the files are physically stored in one or more storage media. In some cases, the files may be stored in cloud storage. Cloud storage is a model of computer data storage in which data, said to be on “the cloud”, is stored remotely in logical pools and is accessible to users over a network, typically the Internet. File-hosting services or cloud-storage services are internet hosting services designed to host files by storing them in the cloud and allowing access via a network, typically the Internet.

These file-hosting services typically use proprietary front ends that users use to organize and manage the files and/or file system structure and proprietary back ends that are used to manage actual storage of the files. These may or may not allow users to change front ends, back ends, directly manage actual storage of the files and so on. Regardless, if such is allowed, it is only under the control of the file-hosting service due to the proprietary nature of the front ends and the back ends. Taking the files and/or the file structure from the file-hosting service to another file-hosting service and/or to a user managed solution, such as one involving a front end and cloud storage not controlled by a file-hosting service may be problematic, particularly if not permitted by the current file-hosting service, and/or may only be available for a fee. Even when migration is possible, hierarchy and/or other relationships among the files and/or file permissions and/or similar information may not be maintained. These technical problems may be overcome via a portable file system structure that uses non-fungible tokens (NFTs).

The present disclosure relates to a portable file system structure that uses NFTs. Access to information regarding a directory structure may be obtained using one or more directory NFTs. This may be used to view and/or modify the directory structure via one or more front ends. Access to one or more of the files themselves, and or decryption of encrypted content, may be obtained via one or more access NFTs, one-time passwords, and/or other authorization mechanisms. The files themselves may be stored in one or more different storage locations, such as cloud storage. The storage locations may be changed independently of the front end, and a front end associated with the directory structure may be de-associated so that another front end may be associated and then used to view and/or modify the directory structure.

The information regarding the directory structure may be stored in the directory NFT, in a directory file referenced by the directory NFT, in one or more blockchains associated with the NFT, and so on. The information regarding the directory structure may be in extensible markup language, another markup language, and/or any other specification that may be used to describe the directory structure, files contained therein, file permissions, hierarchy and/or other relationships among one or more of the files, and so on. The information regarding the directory structure may include one or more references to one or more storage locations (such as in a distributed internet protocol file system storage) of one or more stored files, such as one or more documents. Such a reference may be to a directory service (which may be implemented using one or more directory service NFTs) instead of an actual location.

The directory structure may specify one or more access permissions, lists or other structures detailing the files, relationships between one or more of the files, and so on. Modification of the directory structure may modify the information regarding the directory structure. The directory structure may be created in response to one or more user inputs specifying the directory structure. Modification of the directory structure may involve revoking the directory NFT and creating a new directory NFT and/or modifying a directory file.

The information regarding the directory structure may be presented in one or more ways, such as graphically, via one or more front ends. Different front ends may present the information regarding the same directory structure differently, such as where one front end graphically depicts an entire directory structure whereas another front end only graphically depicts files at a selected directory level.

One or more portions of one or more of the files may be encrypted using one or more different encryption mechanisms. This may raise technical challenges in being able to search the directory structure for one or more files matching one or more search terms if searching would involve searching encrypted content since the front end may not have been involved with the encryption. However, a token or other encryption mechanism that was used to encrypt the one or more portions of the one or more files may be used to encrypt the search term and then the directory NFT may be used with the encrypted search term to search the directory structure and/or one or more of the files.

One or more of the files may be moved from one or more first storage locations to one or more second storage locations. The directory NFT, directory file, and/or directory service may be updated for the move. In some implementations, such a move may involve verifying that a requestor of the move is associated with one or more access NFTs associated with one or more of the files and/or using one or more authentication mechanisms, such as one or more one-time passwords, login credentials, and so on.

As interaction with files associated with the directory structure involves one or more directory NFTs and/or access NFTs associated with one or more blockchains, such interactions may be recorded in one or more blocks of the one or more blockchains. Such blockchains may be used to implement version tracking and/or other mechanisms related to one or more of the files, the directory structure, and so on.

The distributed storage of the files associated with the directory structure may protect the files against virus spread and/or other system-level attacks compared to files stored on the same storage medium. In order to target multiple files in the same directory structure, the information regarding the directory structure would first need to be obtained and then used to locate multiple of the files.

In this way, the present disclosure may provide technological solutions to the technological problems introduced by storing files in cloud and/or similar storage and making them accessible over one or more networks. A system and/or device using the techniques of the present disclosure may be able to provide improved user interfaces, enable switching of front ends, enable migration compatibility prevented and/or controlled via otherwise proprietary systems, enable access and/or modification of one or more directory structures and/or files contained therein, and/or perform various related functions that the system and/or device would not previously have been able to perform absent the technology disclosed herein. This may enable the system and/or device to operate more efficiently while consuming fewer hardware and/or software resources as more resource consuming techniques may be omitted. Further, one or more databases and/or other components may be omitted while still enabling various functions and/or other functions, reducing unnecessary hardware and/or software components, and providing greater system flexibility and security.

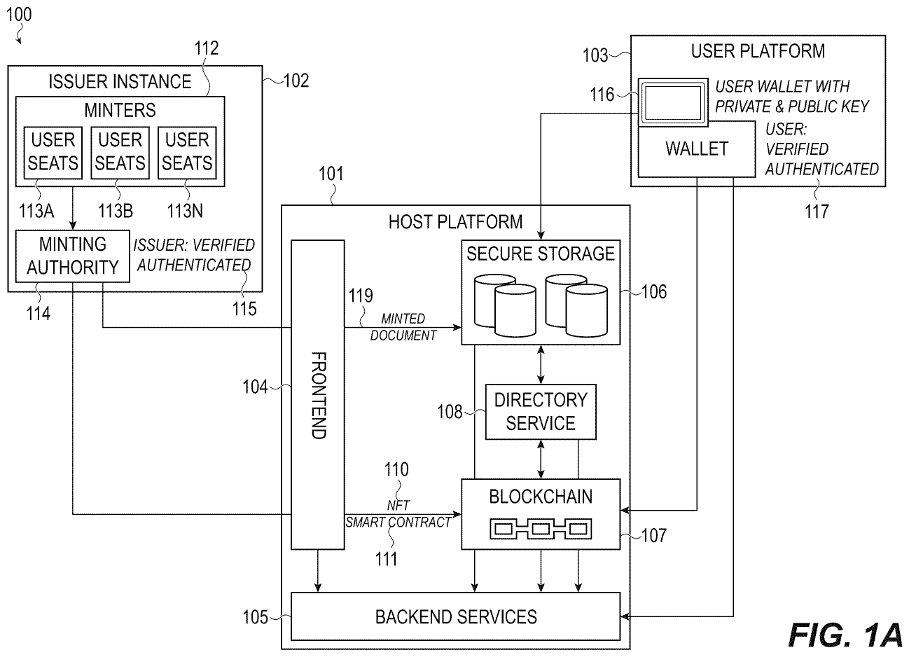

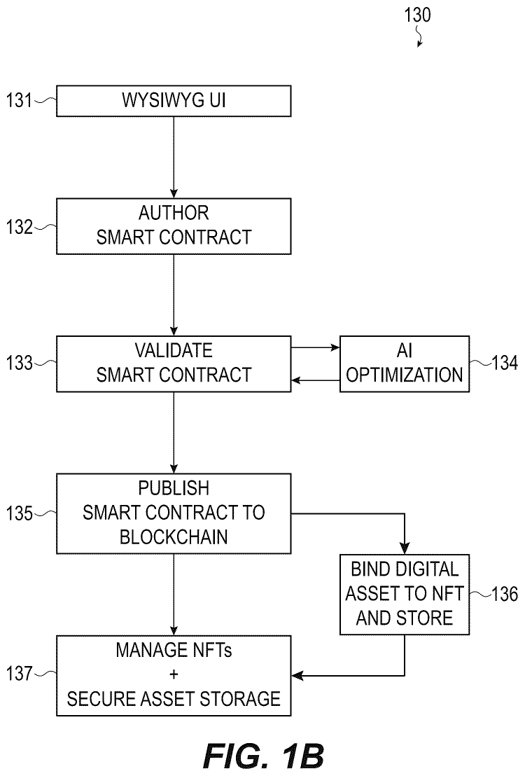

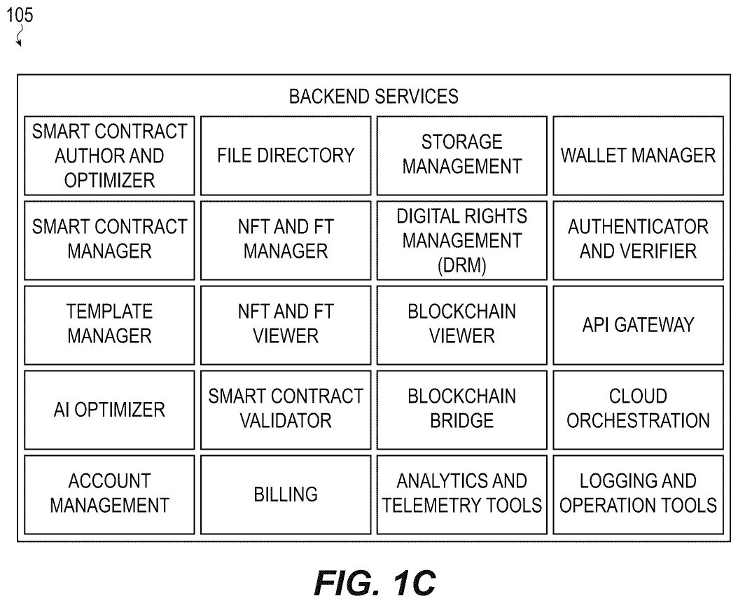

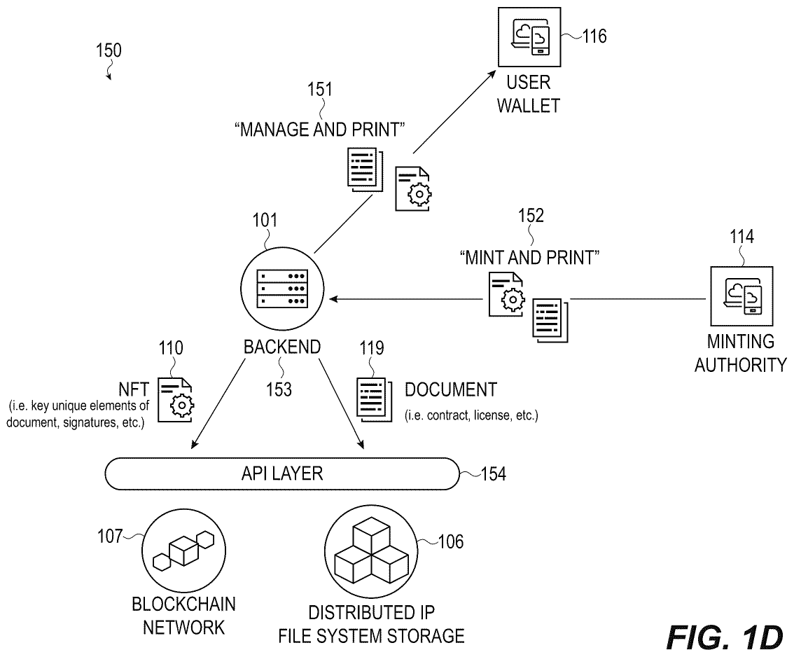

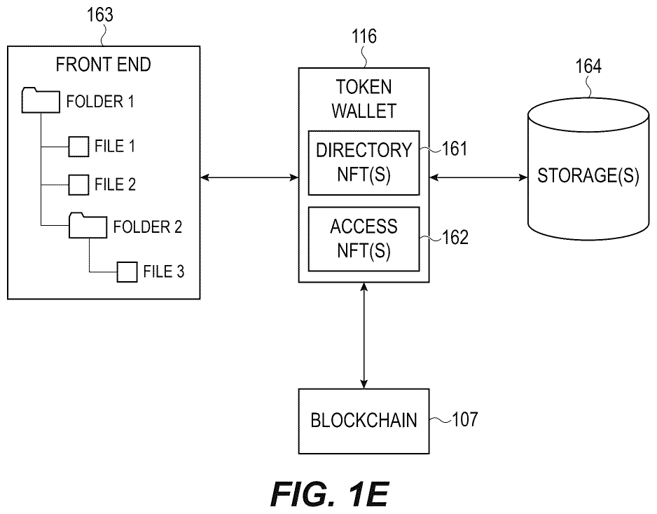

These and other embodiments are discussed below with reference to FIGS. 1A-15. However, those skilled in the art will readily appreciate that the detailed description given herein with respect to these Figures is for explanatory purposes only and should not be construed as limiting.

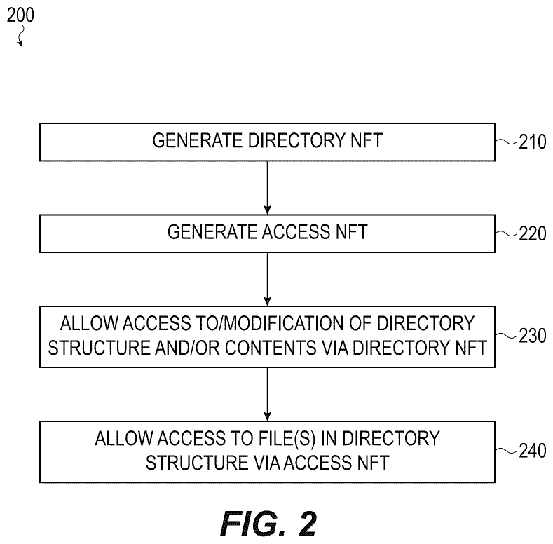

FIG. 1A depicts an example system 100. The system 100 (such as via a host platform 101) may perform various directory service functions. Examples of such operations are discussed in detail below with respect to FIGS. 2 and 4-13.

The system 100 may include a host platform 101 that is operable to create and/or perform one or more transactions and/or other actions related to one or more NFTs 110, smart contracts 111, and/or minted documents 119 on behalf of and/or for one or more other entities, such as one or more issuer instances 102, user platforms 103, intermediaries (not shown), and so on. Creation of the NFTs 110 may involve creation of one or more smart contracts 111, storage of the smart contracts 111 and/or the NFTs 110 in one or more blockchains, automatic creation and/or maintenance of one or more local and/or cloud-based token wallets (an electronic repository associated with storage of at least one or more private keys associated with one or more NFTs 110 and/or other tokens associated with one or more blockchains), and so on. In some cases, the private keys for the NFTs 110 and/or other encrypted and/or unencrypted data (such as one or more public keys, copies of the NFTs 110, payloads, and so on) may be stored in one or more local and/or cloud-based token wallets. The NFT document platform may also be operable to mint one or more documents, such as one or more birth certificates, contracts, and other signed documents, titles (such as house titles, car titles, and so on), prescriptions, licenses and/or identification documents, checks, money, gift cards, and so on. The smart contracts 111 and/or NFTs 110 may correspond to the one or more minted documents 119 and may even be created using data from and/or otherwise associated with the minted documents 119. The NFTs may be usable to authenticate the minted documents 119, evidence ownership of the minted documents 119, control the ability to perform transactions regarding the minted documents 119, and so on.

For example, the host platform 101 may implement a portable file system structure that uses NFTs. Access to information regarding a directory structure may be obtained using one or more directory NFTs. This may be used to view and/or modify the directory structure via one or more front ends. Access to one or more of the files themselves, and or decryption of encrypted content, may be obtained via one or more access NFTs, one-time passwords, and/or other authorization mechanisms. The files themselves may be stored in one or more different storage locations, such as cloud storage. The storage locations may be changed independently of the front end, and a front end associated with the directory structure may be de-associated so that another front end may be associated and then used to view and/or modify the directory structure.

The NFT may be involved in one or more directory services using one or more techniques specified in application Ser. No. 18/431,666, which is incorporated by reference in its entirety. This may add capabilities that were not previously possible while improving operation of computer systems involved by reducing and/or eliminating consumption of the hardware and/or software resources that would have otherwise been used.

Typically, a smart contract and a fixed URL (uniform resource locator) to a location (typically to a fixed location in IPFS) where the asset is stored (the payload) are embedded in each NFT. Because the URL is fixed, the asset cannot be moved. By way of contrast, the present disclosure embeds a portable (or intermediate) URL in the NFT that points to the address where the asset is stored. Because this URL is portable, the URL can be moved, the host of the directory service can be changed, and/or the asset may be moved (though these operations may be performed independently such that the URL may be moved without changing the host or moving the asset, the asset may be moved without moving the URL or changing the host, or the host may be changed without moving the asset or), without having to revoke the NFT and generate a new NFT. This may reduce system burdens, resource consumption, storage requirements, cost, and so on versus repeatedly revoking and re-creating large numbers of NFTs.

In this way, the present disclosure may provide technological solutions to the technological problems introduced by storing files in cloud and/or similar storage and making them accessible over one or more networks. The system 100 may be able to provide improved user interfaces, enable switching of front ends, enable migration compatibility prevented and/or controlled via otherwise proprietary systems, enable access and/or modification of one or more directory structures and/or files contained therein, and/or perform various related functions that the system and/or device would not previously have been able to perform absent the technology disclosed herein. This may enable the system 100 to operate more efficiently while consuming fewer hardware and/or software resources as more resource consuming techniques may be omitted. Further, one or more databases and/or other components may be omitted while still enabling various functions and/or other functions, reducing unnecessary hardware and/or software components, and providing greater system flexibility and security.

The host platform 101 may include one or more frontends 104 and/or one or more backend services 105. The frontend 104 may include one or more application programming interfaces or “APIs”. Similarly, the backend services 105 may be accessed using one or more APIs. The frontend 104 may be usable by one or more issuer instances 102 to request creation of and/or performance of one or more transactions and/or other actions related to one or more NFTs 110, smart contracts 111, and/or minted documents 119. The frontend 104 may interact with one or more unsecure and/or secure storages 106 and/or one or more blockchains 107 to store one or more NFTs 110, smart contracts 111, minted documents 119, and so on. A directory service 108 may by usable by the host platform 101 to associate assets in the one more unsecure and/or secure storages 106 and/or one or more blockchains 107. The frontend 104 and/or the one or more blockchains 107 may be communicably connected to the backend services 105.

The issuer instance 102 may include one or more minters 112 that may include one or more user seats 113A-113N, a minting authority 114, an issuer 115, and so on. The issuer 115 may be verified and authenticated by the host platform 101, such as by communication over a verified connection, using multi-factor authentication (such as a login and/or password, a one-time password sent to a known email address and/or other communication address, one or more authenticator apps, and so on), and so on. The minting authority 114 and/or the issuer instance 102 may be communicably connected to the frontend 104.

The user platform 103 may include a user wallet 116 and a user 117. The user wallet 116 may be a token wallet. The user wallet 116 may store one or more private and/or public keys related to one or more NFTs. The user wallet 116 and/or the user platform 103 may be communicably connected to the one or more unsecure and/or secure storages 106, one or more blockchains 107, and/or backend services 105. The user 117 may be verified and authenticated by the host platform 101, such as by communication over a verified connection, using multi-factor authentication (such as a login and/or password, a one-time password sent to a known email address and/or other communication address, one or more authenticator apps, and so on), and so on.

FIG. 1B depicts a flow 130 of using creation and minting of a smart contract and non-fungible token. The flow may be performed by the system 100 of FIG. 1A. A what you see is what you get (“WYSIWYG”) and/or other user interface 131 may be provided. The user interface 131 may be used to author one or more smart contracts 132. The authored smart contracts may be validated 133 and/or optimized using artificial intelligence (AI) 134. The validated and/or optimized smart contract (and/or any generated related one or more NFTs) may be published to one or more blockchains 135. A digital asset related to the smart contract may be bound to the one or more NFTs and stored 136. The one or more NFTs may then be managed and the digital asset may be securely and/or otherwise stored 137.

Although the flow 130 illustrates a particular flow, it is understood that this is an example. In other implementations, other flows of the same, similar, and/or different operations may be used. Various configurations are possible and contemplated without departing from the scope of the present disclosure.

FIG. 1C depicts a list of backend services 105. The backend services 105 may support and/or be provided by the system 100 of FIG. 1A. The list may include one or more smart contract authors and/or optimizers, file directories, storage management, wallet managers, smart contract managers, NFT and FT managers, digital rights management (DRM), authenticators and/or verifiers, template managers, NFT and/or FT viewers, blockchain viewers, API gateways, AI optimizers, smart contract validators, blockchain bridges, cloud orchestration, account management, billing, analytics and/or telemetry tools, logging and operation tools, and so on.

Although the list illustrates examples of backend services 105, it is understood that this is an example. In other implementations, other backend services 105 may be used. Various configurations are possible and contemplated without departing from the scope of the present disclosure.

FIG. 1D depicts mint-print-manage functions 150. The mint-print-manage functions 150 may be performed and/or supported and/or provided by the system of FIG. 1A. As shown, a host platform 101 may communicate with a user wallet 116 and/or a minting authority 114 to perform manage and print functions 151 and/or mint and print functions 152. The host platform 101 may use a backend 153 and/or an API layer 154 to store one or more NFTs 110 (which may include key unique elements of one or more minted documents 119, signature, and so on) in one or more blockchain 107 networks and/or one or more minted documents 119 (such as one or more contracts, licenses, and so on) in a distributed internet protocol file system storage and/or other unsecure and/or secure storage 106.

Although the mint-print-manage functions 150 are illustrated and described with a particular configuration, it is understood that this is an example. In other implementations, other configurations of the same, similar, and/or different operations may be used. Various configurations are possible and contemplated without departing from the scope of the present disclosure.

FIG. 1E depicts an implementation of a portable file system structure using non-fungible tokens. One or more files may be stored in one or more storages 164 (or backends) and may be associated with a directory structure. A front end 163 may use one or more directory NFTs 161 and/or one or more access NFTs 162 associated with one or more token wallets 116 or user wallets and one or more blockchains 107 to obtain information regarding the directory structure and/or one or more of the files.

The front end 163 is illustrated as displaying a number of folders and files associated with such folders. However, it is understood that this is an example. In other examples, directory structure may include other configurations of files and/or relationships among one or more of the files. Various configurations are possible and contemplated without departing from the scope of the present disclosure.

Returning to FIG. 1A, although the system 100 is illustrated and described as including particular components arranged in a particular configuration, it is understood that this is an example. In a number of implementations, various configurations of various components may be used without departing from the scope of the present disclosure.

For example, the system 100 is illustrated and described as the user platform 103 including the user wallet 116. However, it is understood that this is an example. In various implementations, the system 100 may include a host platform 101 that automatically generates and/or maintains one or more local and/or cloud-based token wallets, such as token wallets associated with one or more communication addresses (such as one or more email addresses, telephone numbers, social media messaging addresses, and so on) of one or more users. This may increase the likelihood that users will use the system 100 as the users do not have to know how to create token wallets, as well as simplifying user interfaces and improving the operation of computing devices used to implement the system 100. Various configurations are possible and contemplated without departing from the scope of the present disclosure.

FIG. 2 depicts a flow chart illustrating a first example method 200 involving a portable file system structure using non-fungible tokens. This method may be performed by the system 100 of FIG. 1A.

At operation 210, an electronic device (such as one or more computing devices associated with the host platform 101 of FIG. 1A, the issuer instance 102 of FIG. 1A, the user platform 103 of FIG. 1A, and/or another device or system) may generate one or more directory NFTs. The directory NFT may be associated with information regarding a directory structure associated with one or more files stored in one or more storage locations. The directory NFT may be associated with one or more blockchains.

At operation 220, the electronic device may generate one or more access NFTs. The access NFT may be used to access one or more of the files, the directory structure, and so on. The access NFT may be associated with one or more blockchains, such as the same blockchains that are associated with the directory NFT.

At operation 230, the electronic device may allow access to/modification of the directory structure and/or contents of the directory structure, such as one or more of the files via the directory NFT. The access and/or modification may be provided via one or more front ends.

At operation 240, the electronic device may allow access to one or more of the files associated with the directory structure via the access NFT. Access may include viewing contents of the one or more files, modifying the one or more files, moving the one or more files, and so on.

Although the example method 200 is illustrated and described as including particular operations performed in a particular order, it is understood that this is an example. In various implementations, various orders of the same, similar, and/or different operations may be performed without departing from the scope of the present disclosure.

For example, the method 200 is illustrated and described as generating and using the access NFT. However, it is understood that this is an example. In some implementations, access control may be implemented using other access credentials, such as a one-time password, and/or generating and/or using the access NFT may be omitted. Various configurations are possible and contemplated without departing from the scope of the present disclosure.

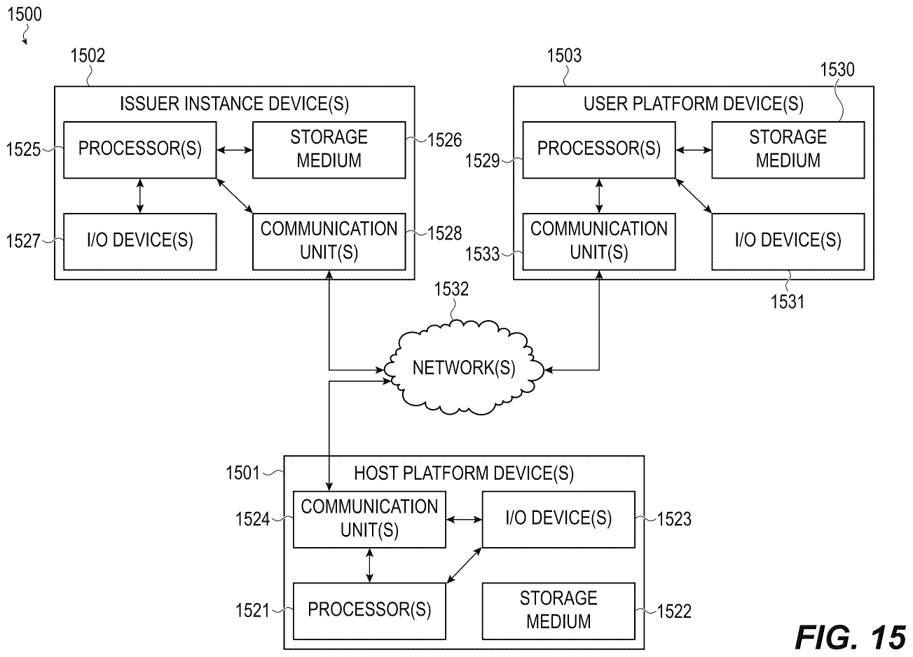

FIG. 15 depicts example relationships 1500 among example components that may be used to implement the system 100 of FIG. 1A.

The host platform 101 of FIG. 1 may be implemented using one or more host platform devices 1501. The host platform device 1501 may be any kind of electronic device. Examples of such devices include, but are not limited to, one or more desktop computing devices, laptop computing devices, server computing devices, mobile computing devices, tablet computing devices, set top boxes, digital video recorders, televisions, displays, wearable devices, smart phones, digital media players, and so on. The host platform device 1501 may include one or more processors 1521 and/or other processing units and/or controllers, one or more non-transitory storage media 1522 (which may take the form of, but is not limited to, a magnetic storage medium; optical storage medium; magneto-optical storage medium; read only memory; random access memory; erasable programmable memory; flash memory; and so on), one or more communication units 1524 (such as one or more network adapters and/or other devices used by a device to communicate with one or more other devices), one or more input and/or output device(s) 1523 (such as one or more displays, speakers, touch screens, computer mice, track pads, keyboards, printers, and so on) and/or one or more other components. The processor 1521 may execute instructions stored in the non-transitory storage medium 1522 to perform various functions. Such functions may include any of the functions discussed herein with respect to the host platform 101 of FIG. 1A, communicating with one or more issuer instance devices 1502, user platform devices 1503, and/or one or more other devices via one or more wired and/or wireless networks 1532; and so on. Alternatively and/or additionally, the host platform device 1501 may involve one or more memory allocations configured to store at least one executable asset and one or more processor allocations configured to access the one or more memory allocations and execute the at least one executable asset to instantiate one or more processes and/or services, such as one or more host platform services, and so on.

Similarly, the issuer instance 102 of FIG. 1A may be implemented using one or more issuer instance devices 1502. The issuer instance device 1502 may be any kind of electronic device. Examples of such devices include, but are not limited to, one or more desktop computing devices, laptop computing devices, server computing devices, mobile computing devices, tablet computing devices, set top boxes, digital video recorders, televisions, displays, wearable devices, smart phones, digital media players, and so on. The issuer instance device 1502 may include one or more processors 1525 and/or other processing units and/or controllers, one or more non-transitory storage media 1526 (which may take the form of, but is not limited to, a magnetic storage medium; optical storage medium; magneto-optical storage medium; read only memory; random access memory; erasable programmable memory; flash memory; and so on), one or more communication units 1528 (such as one or more network adapters and/or other devices used by a device to communicate with one or more other devices), one or more input and/or output device(s) 1527 (such as one or more displays, speakers, touch screens, computer mice, track pads, keyboards, printers, and so on) and/or one or more other components. The processor 1525 may execute instructions stored in the non-transitory storage medium 1526 to perform various functions. Such functions may include any of the functions discussed herein with respect to the issuer instance 102 of FIG. 1A, communicating with one or more host platform devices 1501, user platform devices 1503, and/or one or more other devices via one or more wired and/or wireless networks 1532; and so on. Alternatively and/or additionally, the issuer instance device 1502 may involve one or more memory allocations configured to store at least one executable asset and one or more processor allocations configured to access the one or more memory allocations and execute the at least one executable asset to instantiate one or more processes and/or services, such as one or more issuer instance services, and so on.

Likewise, the user platform 103 of FIG. 1A may be implemented using one or more user platform devices 1503. The user platform device 1503 may be any kind of electronic device. Examples of such devices include, but are not limited to, one or more desktop computing devices, laptop computing devices, server computing devices, mobile computing devices, tablet computing devices, set top boxes, digital video recorders, televisions, displays, wearable devices, smart phones, digital media players, and so on. The user platform device 1503 may include one or more processors 1529 and/or other processing units and/or controllers, one or more non-transitory storage media 1530 (which may take the form of, but is not limited to, a magnetic storage medium; optical storage medium; magneto-optical storage medium; read only memory; random access memory; erasable programmable memory; flash memory; and so on), one or more communication units 1533 (such as one or more network adapters and/or other devices used by a device to communicate with one or more other devices), one or more input and/or output device(s) 1531 (such as one or more displays, speakers, touch screens, computer mice, track pads, keyboards, printers, and so on) and/or one or more other components. The processor 1529 may execute instructions stored in the non-transitory storage medium 1530 to perform various functions. Such functions may include any of the functions discussed herein with respect to the user platform 103 of FIG. 1A, communicating with one or more issuer instance devices 1502, host platform devices 1501, and/or one or more other devices via one or more wired and/or wireless networks 1532; and so on. Alternatively and/or additionally, the user platform device 1503 may involve one or more memory allocations configured to store at least one executable asset and one or more processor allocations configured to access the one or more memory allocations and execute the at least one executable asset to instantiate one or more processes and/or services, such as one or more user platform services, and so on.

Additionally, FIG. 1A may involve one or more other devices not shown. Such other devices may be any kind of electronic device. Examples of such other devices include, but are not limited to, one or more desktop computing devices, laptop computing devices, server computing devices, mobile computing devices, tablet computing devices, set top boxes, digital video recorders, televisions, displays, wearable devices, smart phones, digital media players, and so on. The other devices may include one or more processors and/or other processing units and/or controllers, one or more non-transitory storage media (which may take the form of, but is not limited to, a magnetic storage medium; optical storage medium; magneto-optical storage medium; read only memory; random access memory; erasable programmable memory; flash memory; and so on), one or more communication units (such as one or more network adapters and/or other devices used by a device to communicate with one or more other devices), one or more input and/or output components (such as one or more displays, speakers, touch screens, computer mice, track pads, keyboards, printers, and so on) and/or one or more other components. The processor may execute instructions stored in the non-transitory storage medium to perform various functions. Such functions may include any of the functions discussed herein, communicating with one or more issuer instance devices 1502, user platform devices 1503, host platform devices 1501, and/or one or more other devices via one or more wired and/or wireless networks 1532; and so on. Alternatively and/or additionally, the other devices may involve one or more memory allocations configured to store at least one executable asset and one or more processor allocations configured to access the one or more memory allocations and execute the at least one executable asset to instantiate one or more processes and/or services, such as one or more other device services, and so on.

As used herein, the term “computing resource” (along with other similar terms and phrases, including, but not limited to, “computing device” and “computing network”) refers to any physical and/or virtual electronic device or machine component, or set or group of interconnected and/or communicably coupled physical and/or virtual electronic devices or machine components, suitable to execute or cause to be executed one or more arithmetic or logical operations on digital data.

Example computing resources contemplated herein include, but are not limited to: single or multi-core processors; single or multi-thread processors; purpose-configured co-processors (e.g., graphics processing units, motion processing units, sensor processing units, and the like); volatile or non-volatile memory; application-specific integrated circuits; field-programmable gate arrays; input/output devices and systems and components thereof (e.g., keyboards, mice, trackpads, generic human interface devices, video cameras, microphones, speakers, and the like); networking appliances and systems and components thereof (e.g., routers, switches, firewalls, packet shapers, content filters, network interface controllers or cards, access points, modems, and the like); embedded devices and systems and components thereof (e.g., system(s)-on-chip, Internet-of-Things devices, and the like); industrial control or automation devices and systems and components thereof (e.g., programmable logic controllers, programmable relays, supervisory control and data acquisition controllers, discrete controllers, and the like); vehicle or aeronautical control devices and systems and components thereof (e.g., navigation devices, safety devices or controllers, security devices, and the like); corporate or business infrastructure devices or appliances (e.g., private branch exchange devices, voice-over internet protocol hosts and controllers, end-user terminals, and the like); personal electronic devices and systems and components thereof (e.g., cellular phones, tablet computers, desktop computers, laptop computers, wearable devices); personal electronic devices and accessories thereof (e.g., peripheral input devices, wearable devices, implantable devices, medical devices, and so on); and so on. It may be appreciated that the foregoing examples are not exhaustive.

Example information can include, but may not be limited to: personal identification information (e.g., names, social security numbers, telephone numbers, email addresses, physical addresses, driver's license information, passport numbers, and so on); identity documents (e.g., driver's licenses, passports, government identification cards or credentials, and so on); protected health information (e.g., medical records, dental records, and so on); financial, banking, credit, or debt information; third-party service account information (e.g., usernames, passwords, social media handles, and so on); encrypted or unencrypted files; database files; network connection logs; shell history; filesystem files; libraries, frameworks, and binaries; registry entries; settings files; executing processes; hardware vendors, versions, and/or information associated with the compromised computing resource; installed applications or services; password hashes; idle time, uptime, and/or last login time; document files; product renderings; presentation files; image files; customer information; configuration files; passwords; and so on. It may be appreciated that the foregoing examples are not exhaustive.

The foregoing examples and description of instances of purpose-configured software, whether accessible via API as a request-response service, an event-driven service, or whether configured as a self-contained data processing service are understood as not exhaustive. In other words, a person of skill in the art may appreciate that the various functions and operations of a system such as described herein can be implemented in a number of suitable ways, developed leveraging any number of suitable libraries, frameworks, first-or third-party APIs, local or remote databases (whether relational, NoSQL, or other architectures, or a combination thereof), programming languages, software design techniques (e.g., procedural, asynchronous, event-driven, and so on or any combination thereof), and so on. The various functions described herein can be implemented in the same manner (as one example, leveraging a common language and/or design), or in different ways. In many embodiments, functions of a system described herein are implemented as discrete microservices, which may be containerized or executed/instantiated leveraging a discrete virtual machine, that are only responsive to authenticated API requests from other microservices of the same system. Similarly, each microservice may be configured to provide data output and receive data input across an encrypted data channel. In some cases, each microservice may be configured to store its own data in a dedicated encrypted database; in others, microservices can store encrypted data in a common database; whether such data is stored in tables shared by multiple microservices or whether microservices may leverage independent and separate tables/schemas can vary from embodiment to embodiment. As a result of these described and other equivalent architectures, it may be appreciated that a system such as described herein can be implemented in a number of suitable ways. For simplicity of description, many embodiments that follow are described in reference to an implementation in which discrete functions of the system are implemented as discrete microservices. It is appreciated that this is merely one possible implementation.

As described herein, the term “processor” refers to any software and/or hardware-implemented data processing device or circuit physically and/or structurally configured to instantiate one or more classes or objects that are purpose-configured to perform specific transformations of data including operations represented as code and/or instructions included in a program that can be stored within, and accessed from, a memory. This term is meant to encompass a single processor or processing unit, multiple processors, multiple processing units, analog or digital circuits, or other suitably configured computing element or combination of elements.

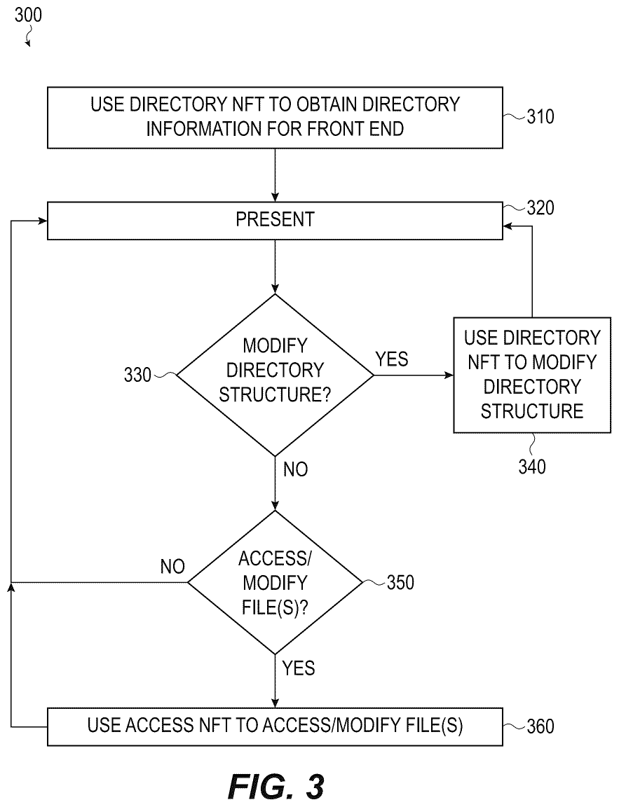

FIG. 3 depicts a flow chart illustrating a second example method 300 involving a portable file system structure using non-fungible tokens. This method 300 may be performed by the system 100 of FIG. 1A.

At operation 310, an electronic device (such as one or more computing devices associated with the host platform 101 of FIG. 1A, the issuer instance 102 of FIG. 1A, the user platform 103 of FIG. 1A, and/or another device or system) may use one or more directory NFTs to obtain directory information for one or more front ends. The directory information may be associated with a directory structure that is associated with one or more files stored in one or more storage locations.

At operation 320, the electronic device may present the directory information. The electronic device may present the directory information via the front end. The information may be presented graphically and/or via text.

At operation 330, the electronic device may determine whether or not to modify the directory structure. The electronic device may determine to modify the directory structure when user input indicating to modify the directory structure is received. If so, the flow may proceed to operation 340. Otherwise, the operation may proceed to 350.

At operation 340, the electronic device may use the directory NFT to modify the directory structure. This may involve modifying information regarding the directory structure, which may be associated with the directory NFT, included in a directory file referenced by the directory NFT, stored in one or more blocks of a blockchain associated with the directory NFT, and so on. The flow may then return to operation 320 where the electronic device may present the modified directory information.

At operation 350, the electronic device may determine whether or not to access and/or modify one or more of the files. The electronic device may access and/or modify one or more of the files when user input indicating to access and/or modify one or more of the files is received. If so, the flow may proceed to operation 360 where the electronic device may use one or more access NFTs to access and/or modify the one or more files before the flow returns to operation 320 where the electronic device may present the directory information. Otherwise, the operation may return directly to operation 320 where the electronic device may present the directory information.

In various examples, this example method 300 may be implemented as a group of interrelated software modules or components that perform various functions discussed herein. These software modules or components may be executed within a cloud network and/or by one or more computing devices, such as one or more computing devices associated with the host platform 101 of FIG. 1A, the issuer instance 102 of FIG. 1A, the user platform 103 of FIG. 1A, and/or another device or system.

Although the example method 300 is illustrated and described as including particular operations performed in a particular order, it is understood that this is an example. In various implementations, various orders of the same, similar, and/or different operations may be performed without departing from the scope of the present disclosure.

For example, the method 300 is illustrated and described as using an access NFT to access and/or modify one or more files. However, it is understood that this is an example. In some implementations, access control may be implemented using other access credentials, such as a one-time password, and using the access NFT may be omitted. Various configurations are possible and contemplated without departing from the scope of the present disclosure.

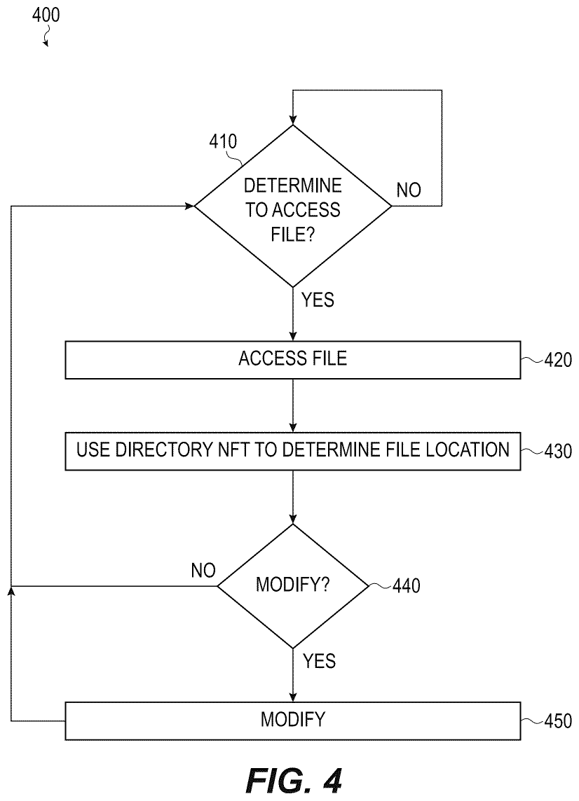

FIG. 4 depicts a flow chart illustrating a third example method 400 involving a portable file system structure using non-fungible tokens. This method 400 may be performed by the system 100 of FIG. 1A.

At operation 410, an electronic device (such as one or more computing devices associated with the host platform 101 of FIG. 1A, the issuer instance 102 of FIG. 1A, the user platform 103 of FIG. 1A, and/or another device or system) may determine whether or not to access a file. The file may be one of a number of files associated with a directory structure. The electronic device may do so in response to user input indicating to access the file. If not, the flow may return to operation 410 where the electronic device may again determine whether or not to access a file. Otherwise, the flow may proceed to operation 420.

At operation 420, the electronic device may access the file. The flow may proceed to operation 430 where the electronic device may use the directory NFT to determine a file location for the file. The file location may be specified in the directory NFT, in a directory file associated with the directory NFT, in one or more blocks of a blockchain associated with the directory NFT, and so on.

At operation 440, the electronic device may determine whether or not to modify the file. If so, the flow may proceed to operation 450 where the electronic device may modify the file before the flow returns to operation 410 where the electronic device may again determine whether or not to access a file. Otherwise, the flow may proceed directly to operation 410 where the electronic device may again determine whether or not to access a file.

In various examples, this example method 400 may be implemented as a group of interrelated software modules or components that perform various functions discussed herein. These software modules or components may be executed within a cloud network and/or by one or more computing devices, such as one or more computing devices associated with the host platform 101 of FIG. 1A, the issuer instance 102 of FIG. 1A, the user platform 103 of FIG. 1A, and/or another device or system.

Although the example method 400 is illustrated and described as including particular operations performed in a particular order, it is understood that this is an example. In various implementations, various orders of the same, similar, and/or different operations may be performed without departing from the scope of the present disclosure.

For example, the method 400 may include further operations, such as determining whether or not access to the file is authorized. However, it is understood that this is an example. Various configurations are possible and contemplated without departing from the scope of the present disclosure.

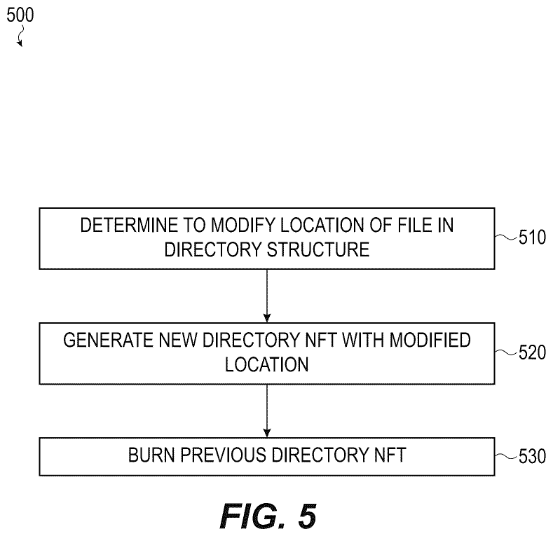

FIG. 5 depicts a flow chart illustrating a fourth example method 500 involving a portable file system structure using non-fungible tokens. This method 500 may be performed by the system 100 of FIG. 1A.

At operation 510, an electronic device (such as one or more computing devices associated with the host platform 101 of FIG. 1A, the issuer instance 102 of FIG. 1A, the user platform 103 of FIG. 1A, and/or another device or system) may determine to modify the location of a file in a directory structure. The flow may then proceed to operation 520 where the electronic device may generate a new directory NFT with the modified location. The flow may then proceed to operation 530 where the electronic device may burn the previous the directory NFT. Burning the previous directory NFT may involve revoking the previous directory NFT.

Although the example method 500 is illustrated and described as including particular operations performed in a particular order, it is understood that this is an example. In various implementations, various orders of the same, similar, and/or different operations may be performed without departing from the scope of the present disclosure.

For example, the method 500 is described as generating a new directory NFT and burning the previous directory NFT. However, it is understood that this is an example. In other implementations, the file location may instead be updated with the modified location, such as in a directory file associated with the directory NFT. Various configurations are possible and contemplated without departing from the scope of the present disclosure.

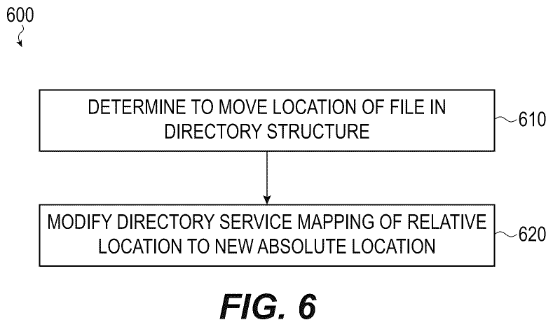

FIG. 6 depicts a flow chart illustrating a fifth example method 600 involving a portable file system structure using non-fungible tokens. This method 600 may be performed by the system 100 of FIG. 1A.

At operation 610, an electronic device (such as one or more computing devices associated with the host platform 101 of FIG. 1A, the issuer instance 102 of FIG. 1A, the user platform 103 of FIG. 1A, and/or another device or system) may determine to move the location of a file in a directory structure. The flow may then proceed to operation 620 where the electronic device may modify a directory service mapping of the relative location of the file (such as is specified in a directory NFT, a directory file associated with the directory NFT, a blockchain associated with the directory NFT, and so on) to a new absolute location corresponding to the location to which the file is moved.

In various examples, this example method 600 may be implemented as a group of interrelated software modules or components that perform various functions discussed herein. These software modules or components may be executed within a cloud network and/or by one or more computing devices, such as one or more computing devices associated with the host platform 101 of FIG. 1A, the issuer instance 102 of FIG. 1A, the user platform 103 of FIG. 1A, and/or another device or system.

Although the example method 600 is illustrated and described as including particular operations performed in a particular order, it is understood that this is an example. In various implementations, various orders of the same, similar, and/or different operations may be performed without departing from the scope of the present disclosure.

For example, the method 600 is illustrated and described as modifying the directory service mapping. However, it is understood that this is an example. In various implementations, the method 600 may communicate with a directory service to modify the directory service mapping. Various configurations are possible and contemplated without departing from the scope of the present disclosure.

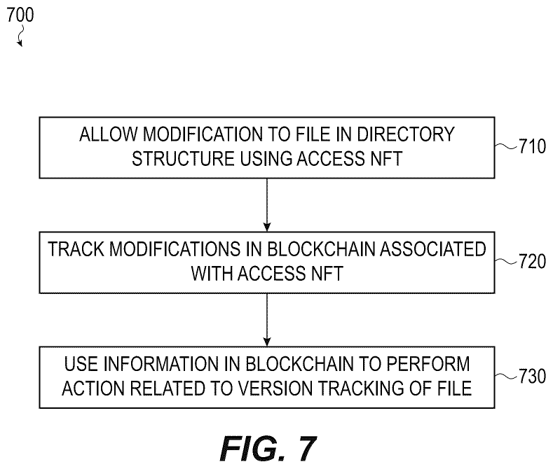

FIG. 7 depicts a flow chart illustrating a sixth example method 700 involving a portable file system structure using non-fungible tokens. This method 700 may be performed by the system 100 of FIG. 1A.

At operation 710, an electronic device (such as one or more computing devices associated with the host platform 101 of FIG. 1A, the issuer instance 102 of FIG. 1A, the user platform 103 of FIG. 1A, and/or another device or system) may allow a modification to a file in a directory structure using an access NFT. At operation 720, the electronic device may track the modifications in a blockchain associated with the access NFT. At operation 730, the electronic device may use information in the blockchain to perform one or more actions related to version tracking of the file.

For example, version tracking may reconstruct previous versions of a file, track who made modifications, and so on. Various configurations are possible and contemplated without departing from the scope of the present disclosure.

In various examples, this example method 700 may be implemented as a group of interrelated software modules or components that perform various functions discussed herein. These software modules or components may be executed within a cloud network and/or by one or more computing devices, such as one or more computing devices associated with the host platform 101 of FIG. 1A, the issuer instance 102 of FIG. 1A, the user platform 103 of FIG. 1A, and/or another device or system.

Although the example method 700 is illustrated and described as including particular operations performed in a particular order, it is understood that this is an example. In various implementations, various orders of the same, similar, and/or different operations may be performed without departing from the scope of the present disclosure.

For example, the method 700 is illustrated and described as performing version tracking of the file. However, it is understood that this is an example. In various implementations, the method 700 may perform version tracking of one or more other files, information on the directory structure, the directory structure, and so on. Various configurations are possible and contemplated without departing from the scope of the present disclosure.

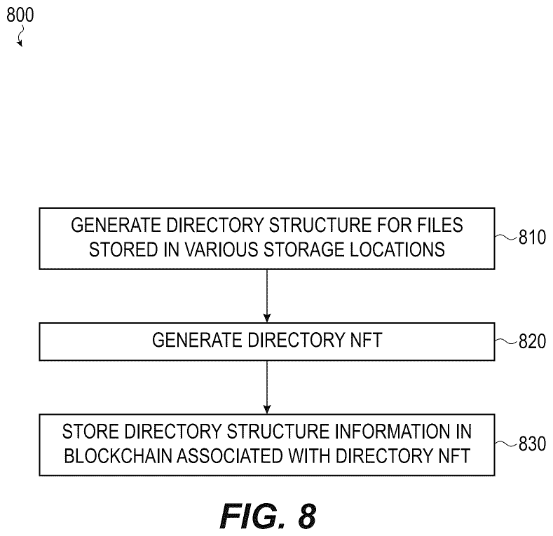

FIG. 8 depicts a flow chart illustrating a seventh example method 800 involving a portable file system structure using non-fungible tokens. This method 800 may be performed by the system 100 of FIG. 1A.

At operation 810, an electronic device (such as one or more computing devices associated with the host platform 101 of FIG. 1A, the issuer instance 102 of FIG. 1A, the user platform 103 of FIG. 1A, and/or another device or system) may generate a directory structure for files stored in various storage locations. The electronic device may generate the directory structure based at least in part on user input.

At operation 820, the electronic device may generate a directory NFT corresponding to the directory structure. At operation 830, the electronic device may store directory structure information in one or more blockchains associated with the directory NFT.

In various examples, this example method 800 may be implemented as a group of interrelated software modules or components that perform various functions discussed herein. These software modules or components may be executed within a cloud network and/or by one or more computing devices, such as one or more computing devices associated with the host platform 101 of FIG. 1A, the issuer instance 102 of FIG. 1A, the user platform 103 of FIG. 1A, and/or another device or system.

Although the example method 800 is illustrated and described as including particular operations performed in a particular order, it is understood that this is an example. In various implementations, various orders of the same, similar, and/or different operations may be performed without departing from the scope of the present disclosure.

For example, the method 800 may include other operations, such as generating an access NFT associated with one or more files in the directory structure. However, it is understood that this is an example. Various configurations are possible and contemplated without departing from the scope of the present disclosure.

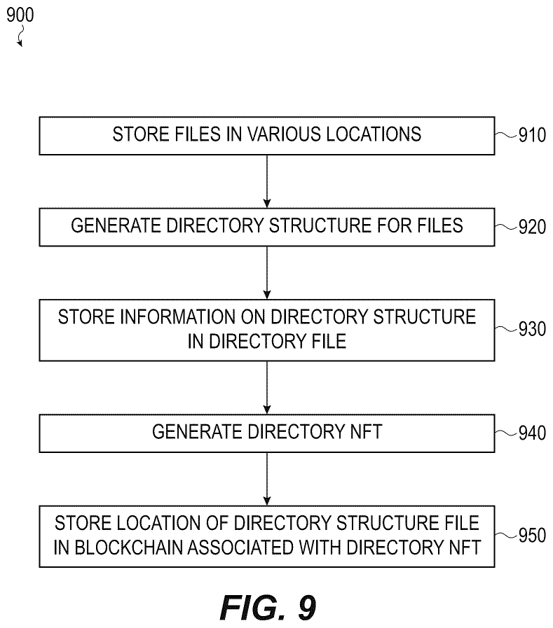

FIG. 9 depicts a flow chart illustrating an eighth example method 900 involving a portable file system structure using non-fungible tokens. This method 900 may be performed by the system 100 of FIG. 1A.

At operation 910, an electronic device (such as one or more computing devices associated with the host platform 101 of FIG. 1A, the issuer instance 102 of FIG. 1A, the user platform 103 of FIG. 1A, and/or another device or system) may store one or more files in various storage locations.

At operation 920, the electronic device may generate a directory structure for the one or more files. At operation 930, the electronic device may store information on the directory structure in a directory file.

At operation 940, the electronic device may generate a directory NFT. The directory NFT may be associated with the directory file.

At operation 950, the electronic device may store a location of the directory file in one or more blockchains associated with the directory NFT.

In various examples, this example method 900 may be implemented as a group of interrelated software modules or components that perform various functions discussed herein. These software modules or components may be executed within a cloud network and/or by one or more computing devices, such as one or more computing devices associated with the host platform 101 of FIG. 1A, the issuer instance 102 of FIG. 1A, the user platform 103 of FIG. 1A, and/or another device or system.

Although the example method 900 is illustrated and described as including particular operations performed in a particular order, it is understood that this is an example. In various implementations, various orders of the same, similar, and/or different operations may be performed without departing from the scope of the present disclosure.

For example, the method 900 is illustrated and described as storing the information on the directory structure in a directory file. However, it is understood that this is an example. In various implementations, the information on the directory structure may be otherwise stored, such as in the directory NFT or the associated blockchain, and the directory file may be omitted. Various configurations are possible and contemplated without departing from the scope of the present disclosure.

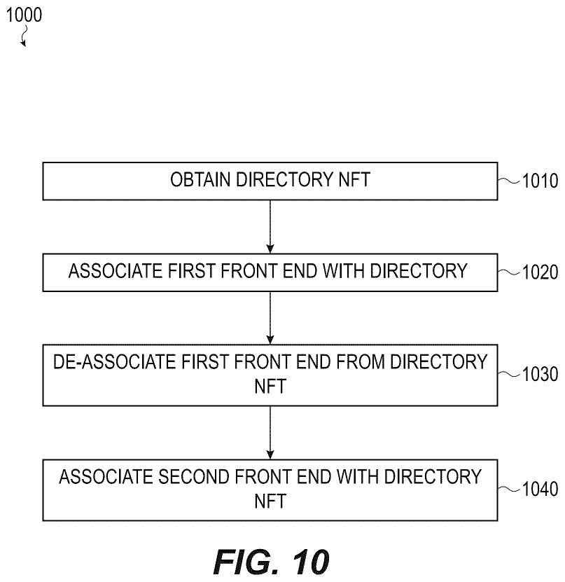

FIG. 10 depicts a flow chart illustrating a ninth example method 1000 involving a portable file system structure using non-fungible tokens. This method 1000 may be performed by the system 100 of FIG. 1A.

At operation 1010, an electronic device (such as one or more computing devices associated with the host platform 101 of FIG. 1A, the issuer instance 102 of FIG. 1A, the user platform 103 of FIG. 1A, and/or another device or system) may obtain a directory NFT. At operation 1020, the electronic device may associate a first front end with the directory NFT. At operation 1030, the electronic device may de-associate the first front end from the directory NFT. At operation 1040, the electronic device may associate a second front end with the directory NFT.

In various examples, this example method 1000 may be implemented as a group of interrelated software modules or components that perform various functions discussed herein. These software modules or components may be executed within a cloud network and/or by one or more computing devices, such as one or more computing devices associated with the host platform 101 of FIG. 1A, the issuer instance 102 of FIG. 1A, the user platform 103 of FIG. 1A, and/or another device or system.

Although the example method 1000 is illustrated and described as including particular operations performed in a particular order, it is understood that this is an example. In various implementations, various orders of the same, similar, and/or different operations may be performed without departing from the scope of the present disclosure.

For example, the method 1000 is illustrated and described as de-associating the first front end from the directory NFT. However, it is understood that this is an example. In various implementations, the electronic device may associate the directory NFT with the second front end without de-associating the directory NFT from the first front end. In such an implementation, operation 1030 may be omitted. Various configurations are possible and contemplated without departing from the scope of the present disclosure.

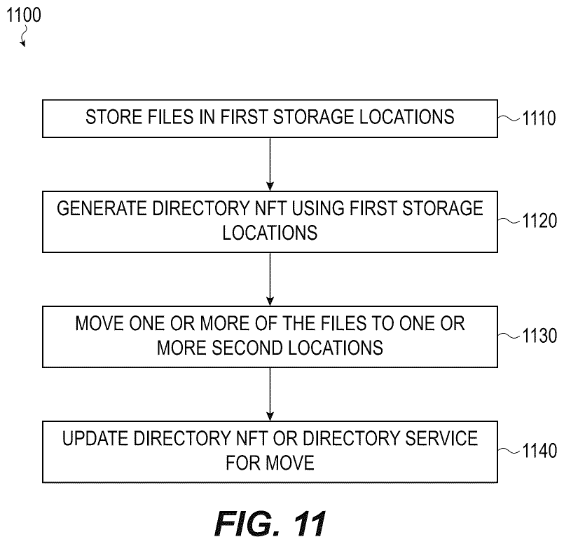

FIG. 11 depicts a flow chart illustrating a tenth example method 1100 involving a portable file system structure using non-fungible tokens. This method 1100 may be performed by the system 100 of FIG. 1A.

At operation 1110, an electronic device (such as one or more computing devices associated with the host platform 101 of FIG. 1A, the issuer instance 102 of FIG. 1A, the user platform 103 of FIG. 1A, and/or another device or system) may store files in one or more first storage locations. At operation 1120, the electronic device may generate a directory NFT using the one or more first storage locations.

At operation 1130, the electronic device may move one or more of the files to one or more second locations. At operation 1140, the electronic device may update the directory NFT or directory service for the move.

In various examples, this example method 1100 may be implemented as a group of interrelated software modules or components that perform various functions discussed herein. These software modules or components may be executed within a cloud network and/or by one or more computing devices, such as one or more computing devices associated with the host platform 101 of FIG. 1A, the issuer instance 102 of FIG. 1A, the user platform 103 of FIG. 1A, and/or another device or system.

Although the example method 1100 is illustrated and described as including particular operations performed in a particular order, it is understood that this is an example. In various implementations, various orders of the same, similar, and/or different operations may be performed without departing from the scope of the present disclosure.

For example, the method 1100 is illustrated and described as updating the directory NFT for the move. However, it is understood that this is an example. In various implementations, a directory file associated with the directory NFT may instead be updated, the directory NFT may be revoked and re-generated, and so on. Various configurations are possible and contemplated without departing from the scope of the present disclosure.

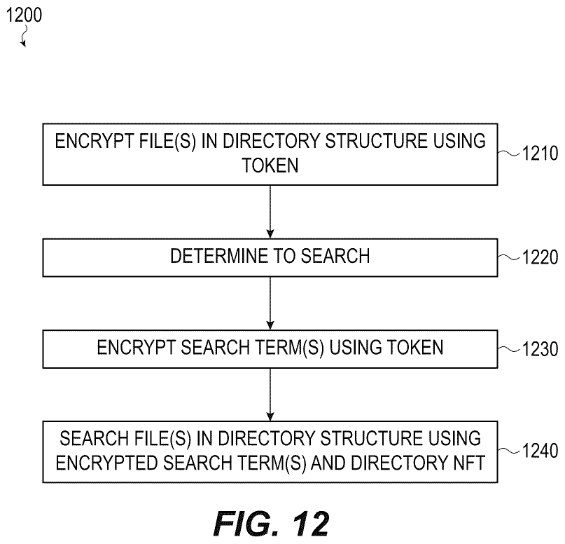

FIG. 12 depicts a flow chart illustrating an eleventh example method 1200 involving a portable file system structure using non-fungible tokens. This method 1200 may be performed by the system 100 of FIG. 1A.

At operation 1210, an electronic device (such as one or more computing devices associated with the host platform 101 of FIG. 1A, the issuer instance 102 of FIG. 1A, the user platform 103 of FIG. 1A, and/or another device or system) may encrypt one or more files in a directory structure using an encryption token.

At operation 1220, the electronic device may determine to search one or more files in the directory structure. At operation 1230, the electronic device may encrypt one or more search terms using the encryption token. At operation 1240, the electronic device may search one or more files in the directory structure using the encrypted search term(s) and the directory NFT.

In various examples, this example method 1200 may be implemented as a group of interrelated software modules or components that perform various functions discussed herein. These software modules or components may be executed within a cloud network and/or by one or more computing devices, such as one or more computing devices associated with the host platform 101 of FIG. 1A, the issuer instance 102 of FIG. 1A, the user platform 103 of FIG. 1A, and/or another device or system.

Although the example method 1200 is illustrated and described as including particular operations performed in a particular order, it is understood that this is an example. In various implementations, various orders of the same, similar, and/or different operations may be performed without departing from the scope of the present disclosure.

For example, the method 1200 is illustrated and described as using an encryption token. However, it is understood that this is an example. In various implementations, other encryption mechanisms may be used. Various configurations are possible and contemplated without departing from the scope of the present disclosure.

By way of another example, the method 1200 is illustrated and described as searching one or more files in the directory structure using the encrypted search term(s) and the directory NFT. However, it is understood that this is an example. In various implementations, the search may also use the unencrypted search term(s). This may be because not all of the files may be encrypted, and/or not all of each file that is encrypted may be encrypted. Various configurations are possible and contemplated without departing from the scope of the present disclosure.

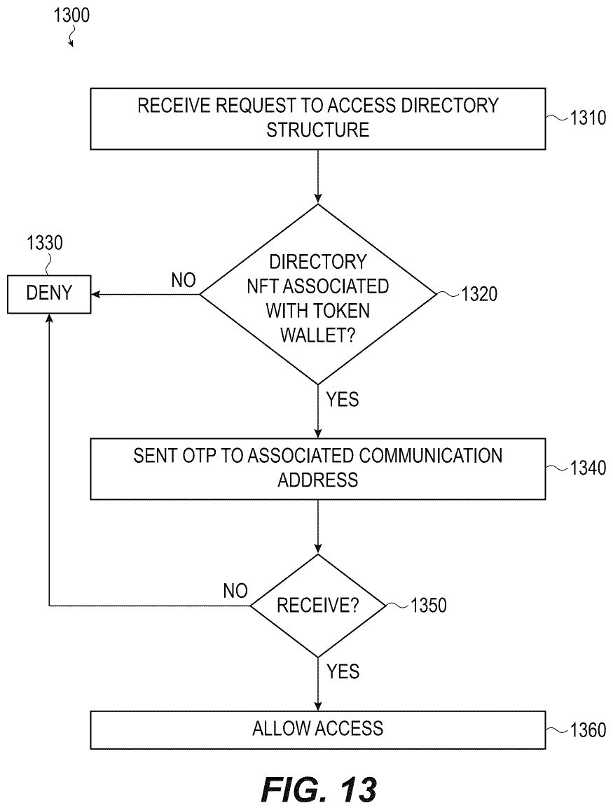

FIG. 13 depicts a flow chart illustrating a twelfth example method 1300 involving a portable file system structure using non-fungible tokens. This method 1300 may be performed by the system 100 of FIG. 1A.

At operation 1310, an electronic device (such as one or more computing devices associated with the host platform 101 of FIG. 1A, the issuer instance 102 of FIG. 1A, the user platform 103 of FIG. 1A, and/or another device or system) may receive a request to access a directory structure.

At operation 1320, the electronic device may determine whether or not a directory NFT is associated with a token wallet associated with the requestor. If not, the flow may proceed to operation 1330 where the electronic device denies the request. Otherwise, the flow may proceed to operation 1340.

At operation 1340, the electronic device may send a one-time password to an associated communication address, such as a communication address associated with the token wallet. The one-time password may be sent via email, text message, and so on.

The flow may proceed to operation 1350 where the electronic device determines whether or not the one-time password is received. If so, the flow may proceed to operation 1360 where the electronic device allows access. Otherwise, the flow may proceed to operation 1330 where the electronic device denies the request.

In various examples, this example method 1300 may be implemented as a group of interrelated software modules or components that perform various functions discussed herein. These software modules or components may be executed within a cloud network and/or by one or more computing devices, such as one or more computing devices associated with the host platform 101 of FIG. 1A, the issuer instance 102 of FIG. 1A, the user platform 103 of FIG. 1A, and/or another device or system.

Although the example method 1300 is illustrated and described as including particular operations performed in a particular order, it is understood that this is an example. In various implementations, various orders of the same, similar, and/or different operations may be performed without departing from the scope of the present disclosure.

For example, the method 1300 is illustrated and described as using a one-time password. However, it is understood that this is an example. In various implementations, other authentication mechanisms may be used, or operations 1340 and/or 1350 may be omitted. Various configurations are possible and contemplated without departing from the scope of the present disclosure.

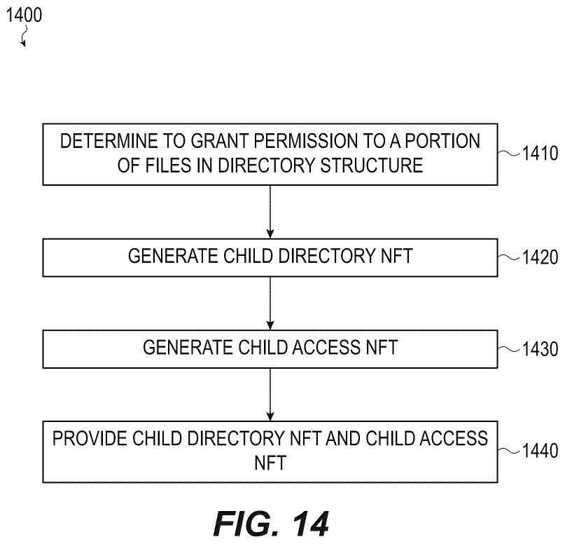

FIG. 14 depicts a flow chart illustrating a thirteenth example method 1400 involving a portable file system structure using non-fungible tokens. This method 1400 may be performed by the system 100 of FIG. 1A.

At operation 1410, an electronic device (such as one or more computing devices associated with the host platform 101 of FIG. 1A, the issuer instance 102 of FIG. 1A, the user platform 103 of FIG. 1A, and/or another device or system) may determine to grant permission to a portion (which may be some, none, or all) of files in a directory structure.

At operation 1420, the electronic device may generate a child directory NFT. The child directory NFT may be a child of a directory NFT associated with the directory structure.

At operation 1430, the electronic device may generate a child access NFT. The child access NFT may be a child of an access NFT associated with the directory structure.

At operation 1440, the electronic device may provide the child directory NFT and the child access NFT. The electronic device may provide the child directory NFT and the child access NFT to enable access to the portion of the files in the directory structure.

In various examples, this example method 1400 may be implemented as a group of interrelated software modules or components that perform various functions discussed herein. These software modules or components may be executed within a cloud network and/or by one or more computing devices, such as one or more computing devices associated with the host platform 101 of FIG. 1A, the issuer instance 102 of FIG. 1A, the user platform 103 of FIG. 1A, and/or another device or system.

Although the example method 1400 is illustrated and described as including particular operations performed in a particular order, it is understood that this is an example. In various implementations, various orders of the same, similar, and/or different operations may be performed without departing from the scope of the present disclosure.

For example, the method 1400 is illustrated and described as generating both the child directory NFT and the child access NFT. However, it is understood that this is an example. In various implementations, one or more of these operations may be omitted. Various configurations are possible and contemplated without departing from the scope of the present disclosure.

In various implementations, a system may include a non-transitory storage medium that stores instructions and at least one processor. The at least one processor may execute the instructions to generate a directory NFT for a directory structure associated with stored files, generate at least one access NFT for at least some of the stored files, allow access to information regarding the directory structure via the directory NFT, allow modification of the directory structure via the directory NFT, and allow access to the at least some of the stored files via the at least one access NFT.

In some examples, the information regarding the directory structure may be stored in the directory NFT. In a number of examples, the information regarding the directory structure may be stored in a directory file referenced by the directory NFT. In various examples, the information regarding the directory structure may be stored in a blockchain associated with the directory NFT. In some examples, the information regarding the directory structure may be in extensible markup language.

In a number of examples, the information regarding the directory structure may include a reference to a storage location of at least one of the stored files. In some such examples, the reference may be to a directory service instead of an actual location of the at least one of the stored files.

In various examples, the modification of the directory structure may modify the information regarding the directory structure. In some examples, the modification of the directory structure may include revoking the directory NFT and creating a new directory NFT.

In a number of examples, at least one of the stored files may be a document. In various examples, the at least one processor may further execute the instructions to present the information regarding the directory structure via at least one front end. In some examples, at least a portion of the stored files may be stored in a distributed internet protocol file system storage. In a number of examples, the at least one processor may further execute the instructions to encrypt at least part of the stored files using a token, determine to search the at least part of the stored files for at least one search term, encrypt the at least one search term using the token to form at least one encrypted search term, and use the directory NFT and the at least one encrypted search term to search the at least part of the stored files.

In some embodiments, a method includes associating a first front end with a directory NFT for a directory structure associated with stored files, using the first front end to access information regarding the directory structure via the directory NFT, de-associating the first front end from the directory NFT, associating a second front end with the directory NFT, and using the second front end to access the information regarding the directory structure via the directory NFT.

In various examples, the first front end and the second front end may depict the information regarding the directory structure differently. In some examples, the method may further include accessing at least one of the stored files via the second front end using at least one access NFT associated with the at least one of the stored files.

In a number of embodiments, a computer program product may include first instructions stored in a non-transitory computer-readable medium and executable by at least one processing unit to determine to store one or more files in one or more first storage locations, second instructions stored in the non-transitory computer-readable medium and executable by the at least one processing unit to create a directory structure for the one or more files using the one or more first storage locations, third instructions stored in the non-transitory computer-readable medium and executable by the at least one processing unit to generate a directory NFT for the directory structure, fourth instructions stored in the non-transitory computer-readable medium and executable by the at least one processing unit to move the one or more files from the one or more first storage locations to one or more second storage locations, and fifth instructions stored in the non-transitory computer-readable medium and executable by the at least one processing unit to update at least one of the directory NFT or a directory service for the move.

In various examples, the directory structure may specify at least one of an access permission, a list of the one or more files, and at least one relationship between the one or more files. In some examples, the directory service may be implemented by a directory service NFT. In a number of examples, moving the one or more files from the one or more first storage locations to the one or more second storage locations may include verifying that a requestor of the move is associated with at least one access NFT associated with the one or more files.

Although the above illustrates and describes a number of embodiments, it is understood that these are examples. In various implementations, various techniques of individual embodiments may be combined without departing from the scope of the present disclosure.

As described above and illustrated in the accompanying figures, the present disclosure relates to a portable file system structure that uses NFTs. Access to information regarding a directory structure may be obtained using one or more directory NFTs. This may be used to view and/or modify the directory structure via one or more front ends. Access to one or more of the files themselves, and or decryption of encrypted content, may be obtained via one or more access NFTs, one-time passwords, and/or other authorization mechanisms. The files themselves may be stored in one or more different storage locations, such as cloud storage. The storage locations may be changed independently of the front end, and a front end associated with the directory structure may be de-associated so that another front end may be associated and then used to view and/or modify the directory structure.

In the present disclosure, the methods disclosed may be implemented as sets of instructions or software readable by a device. Further, it is understood that the specific order or hierarchy of steps in the methods disclosed are examples of sample approaches. In other embodiments, the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a non-transitory machine-readable medium having stored thereon instructions, which may be used to program a computer system (or other electronic devices) to perform a process according to the present disclosure. A non-transitory machine-readable medium includes any mechanism for storing information in a form (e.g., software, processing application) readable by a machine (e.g., a computer). The non-transitory machine-readable medium may take the form of, but is not limited to, a magnetic storage medium (e.g., floppy diskette, video cassette, and so on); optical storage medium (e.g., CD-ROM); magneto-optical storage medium; read only memory (ROM); random access memory (RAM); erasable programmable memory (e.g., EPROM and EEPROM); flash memory; and so on.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

1. A system, comprising:
a non-transitory storage medium that stores instructions; and
at least one processor that executes the instructions to:
generate a directory NFT (non-fungible token) for a directory structure associated with stored files, directory structures being file system structures that organize files into hierarchies of folders or similar structures that involve hierarchical relationships between at least some of the files;
generate at least one access NFT for at least some of the stored files;
allow access to information regarding the directory structure via the directory NFT;
allow modification of the directory structure via the directory NFT; and
allow access to the at least some of the stored files via the at least one access NFT.

2. The system of claim 1, wherein the information regarding the directory structure is stored in the directory NFT.

3. The system of claim 1, wherein the information regarding the directory structure is stored in a directory file referenced by the directory NFT.

4. The system of claim 1, wherein the information regarding the directory structure is stored in a blockchain associated with the directory NFT.

5. The system of claim 1, wherein the information regarding the directory structure comprises extensible markup language.

6. The system of claim 1, wherein the information regarding the directory structure includes a reference to a storage location of at least one of the stored files.

7. The system of claim 6, wherein the reference is to a directory service instead of an actual location of the at least one of the stored files.

8. The system of claim 1, wherein the modification of the directory structure modifies the information regarding the directory structure.

9. The system of claim 1, wherein the modification of the directory structure includes:
revoking the directory NFT; and
creating a new directory NFT.

10. The system of claim 1, wherein at least one of the stored files comprises a document.

11. The system of claim 1, wherein the at least one processor further executes the instructions to present the information regarding the directory structure via at least one front end.

12. The system of claim 1, wherein at least a portion of the stored files are stored in a distributed internet protocol file system storage.

13. The system of claim 1, wherein the at least one processor further executes the instructions to:
encrypt at least part of the stored files using a token;
determine to search the at least part of the stored files for at least one search term;
encrypt the at least one search term using the token to form at least one encrypted search term; and
use the directory NFT and the at least one encrypted search term to search the at least part of the stored files.

14. A method, comprising:
associating a first front end with a directory NFT (non-fungible token) for a directory structure associated with stored files, directory structures being file system structures that organize files into hierarchies of folders or similar structures that involve hierarchical relationships between at least some of the files;
using the first front end to access information regarding the directory structure via the directory NFT;
de-associating the first front end from the directory NFT;
associating a second front end with the directory NFT; and
using the second front end to access the information regarding the directory structure via the directory NFT.

15. The method of claim 14, wherein the first front end and the second front end depict the information regarding the directory structure differently.

16. The method of claim 14, further comprising accessing at least one of the stored files via the second front end using at least one access NFT associated with the at least one of the stored files.

17. A computer program product, comprising:
first instructions stored in a non-transitory computer-readable medium and executable by at least one processing unit to determine to store one or more files in one or more first storage locations;
second instructions stored in the non-transitory computer-readable medium and executable by the at least one processing unit to create a directory structure for the one or more files using the one or more first storage locations, directory structures being file system structures that organize digital files into hierarchies of folders or similar structures that involve hierarchical relationships between at least some of the digital files;
third instructions stored in the non-transitory computer-readable medium and executable by the at least one processing unit to generate a directory NFT (non-fungible token) for the directory structure;
fourth instructions stored in the non-transitory computer-readable medium and executable by the at least one processing unit to move the one or more files from the one or more first storage locations to one or more second storage locations; and
fifth instructions stored in the non-transitory computer-readable medium and executable by the at least one processing unit to update at least one of the directory NFT or a directory service for the move.

18. The computer program product of claim 17, wherein the directory structure specifies at least one of an access permission, a list of the one or more files, and at least one relationship between the one or more files.

19. The computer program product of claim 17, wherein the directory service is implemented by a directory service NFT.

20. The computer program product of claim 17, wherein moving the one or more files from the one or more first storage locations to the one or more second storage locations includes verifying that a requestor of the move is associated with at least one access NFT associated with the one or more files.
